(19) United States
(12) Patent Application Publication
(10) Pub. No.: US 2007/0152199 A1
(43) Pub. Date: Jul. 5, 2007

(54) Composition for the preparation of a thermoset having thermochromic properties

(76) Inventors: Arno Seeboth, Berlin (DE); Detlef Lotzsch, Berlin (DE); Jorg Kriwanek, Berlin (DE); Andreas Lutz, Nideggen (DE)

Correspondence Address: MYERS BIGEL SIBLEY & SAJOVEC, PO BOX 37428, RALEIGH, NC, 27627, US

(21) Appl. No.: 10/549,654

(22) PCT Filed: Mar. 9, 2004
(86) PCT No.: PCT/EP04/02416

§ 371 Date: Jan. 25, 2007

(51) Int. Cl. G02F 1/00

(52) U.S. Cl. 252/583

(57) ABSTRACT

Composition for the preparation of a thermoset having thermochromic properties, consisting of a mixture of a thermochromic composite and starting components for the production of the thermoset. The thermochromic composite has at least one of each of the following components: colorant, developer, flux, surface-active substance and polymer. The thermochromic composite is rendered substantially inert in the mixture with respect to the starting components for the production of the thermoset.

The invention relates to a composition for the preparation of a thermoset having thermochromic properties in accordance with the preamble of patent claim 1 and to the use of such a composition in accordance with the preamble of patent claim 13.

Thermosets are required for a large number of applications. Such applications often relate to fields in which temperature-critical processes are carried out and/or in which active temperature monitoring is necessary. Such temperature monitoring has hitherto been carried out in a conventional manner, that is to say using a thermometer, using thermoelements or like temperature-measuring methods and the associated electronics, that is to say generally in an indirect and very elaborate way. Furthermore, the temperature-measuring methods customary hitherto have generally been used to carry out only local temperature measurement which is assumed to be representative of a relatively large area; exact determination of the temperature over a large surface area is not possible using those conventional methods, however, or is very elaborate. In particular, visual monitoring using the above-mentioned methods is virtually ruled out, because, even if a very large number of temperature-measuring sensors were used, a display device having a very large surface area and showing an unmanageably large amount of temperature data would be required. Particularly in critical fields, such a display panel, which would necessarily be unwieldy, would inevitably lead to problems.

There is therefore an urgent need for a simple temperature-monitoring device which is suitable especially for monitoring temperature over large surface areas. For such an application there have therefore been developed thermochromic compositions and laminates which undergo a change in their optical properties at certain temperatures. Compositions known hitherto generally change from a non-transparent state to a transparent state in the course of an increase or decrease in temperature. Accordingly, exact conclusions as to any particular temperature cannot be drawn or can only be very crude.

In this connection, U.S. Pat. No. 4,617,350 and U.S. Pat. No. 4,861,835 describe for use in optical and optoelectronic apparatus polymer compositions which are based on an acrylic acid or methacrylic acid ester base polymer to which a copolymer of vinylidene fluoride and hexafluoroacetone has been added. The resin compositions disclosed therein do not have colour-change properties, but exhibit only an opaque/transparent transition.

In contrast, EP 0 677 564 describes a thermochromic, opaque/transparent composition which contains a dispersion in a vinyl chloride/vinyl acetate copolymer matrix resin and is obtained by mixing a reversibly thermochromic material with a sterically hindered amine compound. The colour-imparting components are therein first processed to form small particles and then distributed in the vinyl chloride/vinyl acetate copolymer matrix in the form of a dispersion. In that way, reactive resin starting components are prevented from reacting with colour-imparting components to any substantial degree, which has hitherto always resulted in a considerable loss of colour intensity and in a loss of sensitivity to colour change in the event of alterations in temperature. A disadvantage of the process disclosed therein, however, is that the small particles are attacked at least superficially by the reactive components forming the resin, so that, in dependence upon the curing rate of the resin, the above-mentioned disadvantages likewise occur. Furthermore, the process therein can be used only for relatively few colorants, because the colorants must be capable of being processed into solids. Moreover, the colorants therein must exhibit only low reactivity with respect to the starting components of the resin.

The aim of the present invention is to provide a composition for the preparation of a thermoset having thermochromic properties, by means of which the above-mentioned disadvantages are avoided, it being possible for a wider variety of colorant and resin systems to be used than in the prior art.

That aim is achieved by a composition according to patent claim 1.

The aim is achieved especially by a composition for the preparation of a thermoset having thermochromic properties that consists of a mixture of a thermochromic composite and starting components for the production of a thermoset, the thermochromic composite having at least one of each of the following components: colorant, developer, flux, surface-active substance and polymer.

An important aspect of the invention lies in the use of a surface-active substance in combination with a colorant/developer system and a flux. The thermochromic component consists in the colorant/developer combination, including a suitable flux, the components in each case being combined specifically for a certain colour change at a certain temperature. In advantageous manner, the surface-active substance and/or the surface-active substance in combination with the flux enables a very large number of colorant/developer systems to be used, because, by means of the surface-active substance or a combination of the surface-active substance with the flux, the functional groups of the starting components for the production of the thermoset are shielded from the colorant/developer system. The surface-active components and fluxes can also be based on a high molecular weight structure. Accordingly it is possible to use almost any desired colorant/developer systems, the starting components for the production of the thermoset likewise not being subject to any limitation. Depending upon the system used, it is merely necessary for the surface-active substance in particular and, depending upon the colorant system, the flux to be matched to the particular requirements.

According to the invention, the thermochromic composite has been rendered substantially inert in the mixture with respect to the starting components for the production of the thermoset.

Such inertisation can be effected, depending upon the colour intensity of the colorant in question, by micro-encapsulation, while accepting the associated disadvantages, such as, for example, opacification of the capsule. According to the invention, however, it is preferred that the inertisation of the thermochromic composite be achieved by surrounding the composite or, especially, the colorant with a protective shield which consists of a surface-active substance and/or a polymer and/or a mixture of surface-active substance and polymer. The protective shield is preferably in the form of a micelle. It should be emphasised here that the polymer and the surface-active substance, especially a surfactant, need not necessarily be in the form of a mixture in the physical sense, but may also be chemically combined with one another.

In accordance with a preferred embodiment of the invention, the surface-active substance is present in the total system in a concentration which in a polar solvent has in advantageous manner reached or exceeded the critical micelle concentration CMC. Water is preferably used as reference solvent, but there are no restrictions at all in this respect, it being possible for the solvent system used to be matched at any time as desired to the components of the thermochromic composite and to the starting components for the production of the thermoset. The same is true of the pH value to be used and the reaction temperature, which, matched to the substance system in question, are each so chosen that micelle formation can take place. Inside the micelles, according to the invention in advantageous manner at least the colorant/developer system is shielded from the reactive groups of the starting components for the production of the thermoset, so that destruction or denaturing of the colour-imparting substances is avoided.

The flux serves on the one hand for better miscibility of the thermochromic composite with the starting components for the production of the thermoset and in turn for shielding the colorant/developer system from the resin-forming components. Furthermore, controlled by the temperature, the flux initiates the alteration in the state of aggregation of the complex. The structure of the flux ensures a well-adjusted hydrophobicity/hydrophilicity balance. For this purpose, the functional groups are arranged closely adjacent to a terminal hydrophobic structural component. Polymer components here include in a broad sense pre-condensates or monomers. All the starting components for the production of the thermosets may have more than one active functional group. According to the invention, the components of the composition are selected from one or more of the substances mentioned in Table 1 below:

TABLE 1

| | |
|---|---|
| Colorant | phthalides, fluorones, spiropyrans |
| Developer | phenols, organic acids and derivatives thereof |
| Flux | paraffins, saturated and unsaturated |
| | alcohols, acids, esters, amides, amines |
| Surface-active | ionic and non-ionic surfactants, dioctyl |
| | sulfosuccinate, |
| substance | C-12 sulfobetaine, C-16 amine oxide, |
| | Na dodecyl sulfate, |
| | cetyltrimethylammonium bromide |
| Starting components for | polyesters, formaldehyde resins, epoxy resins, |
| the production of the | polyurethanes, hydroxycarboxylic acids, |
| dialcohols, | |
| thermoset | diepoxides, diisocyanates, diamines, |
| | vinyl monomers, diene adducts of |
| | maleic acid, phthalic acid derivatives |
| Polymer | PVA, polyacrylic acid, polyether, |
| | polyester, styrene, polyacrylamide, |
| | polyethylene, polypropylene, maleic |
| | anhydride copolymers, melamine |

The concentrations of the components of the composition that are preferred according to the invention can be found in Table 2 below:

TABLE 2

| | | | especially |
|---|---|---|---|
| | | preferred | preferred |
| Component | % by weight | % by weight | % by weight |
| Colorant | 0.005-0.8 | 0.01-0.5 | 0.1-0.25 |
| Developer | 0.005-1.6 | 0.01-1.0 | 0.1-0.5 |
| Flux | 0.5-6.5 | 0.1-6.0 | 1.0-3.0 |
| Surface-active substance | 0.008-2.3 | 0.01-2.0 | 0.2-0.6 |
| Starting components for the | 87.5-99.9 | 90.0-99.5 | 95.0-98.5 |
| production of the thermoset | | | |
| Polymer | 0.05-7.3 | 0.11-6.1 | 0.5-3.0 |

In advantageous manner, the thermochromic composite according to the invention makes it possible to prepare a thermoset which exhibits at least one clearly defined colour change in dependence upon the temperature. The colour change corresponds to a defined colour transition from a first colour to a second colour, a colour transition in the form of mixtures of the first and second colours not taking place or taking place only to a much lesser degree. Accordingly, for example, a colour change from blue as first colour to red as second colour can take place without passing through intermediate violet shades. The composition according to the invention can accordingly advantageously be used for the production of thermosets which exhibit a clearly defined colour change at a certain transition temperature and accordingly can be used, for example, as an indicator of critical temperatures, without it being necessary for a colour transition to be interpreted, which often is subject to subjective influences.

According to the invention, the thermochromic composite may contain a plurality of colorant/developer systems each of which represents at least one clearly defined colour change, so that a large temperature range with a plurality of transition temperatures can be covered.

According to the invention, preferred colorant/developer systems, in addition to performing at least one clearly defined colour change, are able to perform at least one further visually displayable transition to transparent. In this way, depending upon the colorant/developer system, it is ensured that to the observer, depending upon the particular temperature, only one colorant/developer system appears visually active, so that mixed colours caused by interference between different colorant/developer systems are avoided.

In accordance with a further embodiment of the invention, the use of the thermochromic composite in the composition according to the invention also enables a thermoset to be prepared in which, in dependence upon the temperature, a marked colour change, especially a reversible colour change, takes place within a clearly defined temperature range. According to the invention, the temperature range, that is to say the temperature zone within which the colour change is completed, is within a range of 15 K, preferably within a temperature range of 8 K and especially within a temperature range of 2 K.

In advantageous manner it is accordingly possible to respond specifically to a necessary degree of sensitivity in terms of temperature monitoring, it being possible in the case of thermally unproblematic systems to select, for example, a large colour change temperature range of 15 K or more, while thermally sensitive systems are provided with a small colour change temperature range of 2 K or possibly even smaller.

In accordance with a further embodiment of the invention, the thermochromic composite of the composition according to the invention enables a thermoset to be prepared which has a plurality of colour change transition points. This can be realised, firstly, by a colorant/developer system that is able to perform a plurality of colour changes. Alternatively, multiple colour change transition points are achieved by a thermochromic composite having a plurality of colorant/developer systems which are each active at a different temperature. It may also be possible for two or more colorants, each having one or more developer(s), to exhibit activity in respect of developing different colours at different temperatures.

Using the composition according to the invention it is advantageously possible to produce a substantially isotropic thermoset which has the same colour properties in all spatial directions. Accordingly, during the processing of the thermoset the orientation of the thermoset is immaterial, so that processing the thermoset into a product, such as, for example, a moulded article, is considerably simplified.

In accordance with an embodiment of the invention, at least one colour change proceeds irreversibly. In advantageous manner it is possible in accordance with the invention to use such an irreversible colour change, for example, for quality assurance or for some other type of monitoring, especially critical temperature monitoring.

As already mentioned above, in accordance with a further embodiment of the invention at least two of the components of the thermochromic composite can be present functionally within a supramolecular molecule structure. The flux and the surface-active substance are especially suitable for that purpose, the invention also encompassing a chemical combination of colorant and/or developer and/or flux and/or surface-active substance within a structure, but here at different bond points.

Furthermore, the aim of the invention is achieved by the use of an above-mentioned composition in the production of housings, especially of bearings or pumps, scrapers, covers, especially for machines, monitoring and display devices and for visible temperature monitoring, especially in adhesives technology and quality assurance.

Further embodiments of the invention will be found in the subsidiary claims.

The invention will be described in greater detail below with reference to an example.

### EXAMPLE

0.35 g of sulfobetaine having a chain length of 12 carbon atoms and 0.25 g of polyacrylic acid are added to 250 ml of distilled water. The mixture is heated to 85° C. and stirred at 750 rev/min. Then 2.5 g of the colorant complex are added. The colorant complex consists of bisphenol A, crystal violet lactone and 1-octadecanol in a ratio by weight of 2:1:15. The mixture is stirred at 85° C. for a further 2.5 hours. A stable emulsion is formed. 30 g of an aqueous 7.5% solution of methylol melamine are added thereto over a period of 5 min. The mixture is stirred again for 3 hours. The resulting thermochromic composite (TC) can be filtered and dried in simple manner. The TC is added directly, with stirring, to a resin/hardener mixture (ratio by weight 10:4), there being 4:5% by weight TC in the mixture. The finished thermoset or duromer has stable thermochromic properties. At 60° C., it switches reversibly between blue and colourless.

It should be pointed out here that all the above-described details, alone and in any combination, are claimed as being important to the invention. Modifications thereof will be known to the person skilled in the art.

1-13. (canceled)

14. A composition for the preparation of a thermoset having thermochromic properties, consisting of a mixture of a thermochromic composite, which has at least one of each of the following components:
colorant,
developer,
flux,
surface-active substance,
polymer,
and starting components for the production of the thermoset.

15. A composition according to claim 14, in which the thermochromic composite has been rendered substantially inert in the mixture with respect to the starting components for the production of the thermoset.

16. A composition according to claim 15, in which for inertisation the composite is surrounded by a protective shield which consists of a surface-active substance and/or a polymer and/or a mixture of surface-active substance and polymer.

17. A composition according to claim 16, in which the protective shield consists of a micelle.

18. A composition according to claim 14, in which the surface-active substance is present in the mixture in a concentration which reaches or exceeds the critical micelle concentration.

19. A composition according to claim 14, in which the components of the composition are selected from one or more of the substances mentioned in the table below:

| | |
|---|---|
| Colorant | phthalides, fluorones, spiropyrans |
| Developer | phenols, organic acids and derivatives thereof |
| Flux | paraffins, saturated and unsaturated alcohols, |
| | acids, esters, amides, amines |
| Surface-active substance | ionic and non-ionic surfactants, |
| | dioctyl sulfosuccinate, |
| | C-12 sulfobetaine, C-16 amine oxide, Na |
| | dodecyl sulfate, cetyltrimethylammonium |
| | bromide |
| Starting components for | polyesters, formaldehyde resins, epoxy resins, |
| the production of the | polyurethanes, hydroxycarboxylic acids, |
| thermoset | dialcohols, diepoxides, diisocyanates, |
| | diamines, vinyl monomers, |
| | diene adducts of maleic acid, |
| | phthalic acid derivatives |
| Polymer | PVA, polyacrylic acid, polyether, |
| | polyester, styrene, |
| | polyacrylamide, polyethylene, |
| | polypropylene, maleic |
| | anhydride copolymers, melamine |

20. A composition according to claim 14, in which the components of the composition are present in a concentration in accordance with the table below:

| | | | especially |
|---|---|---|---|
| | | preferred | preferred |
| Component | % by weight | % by weight | % by weight |
| Colorant | 0.005-0.8 | 0.01-0.5 | 0.1-0.25 |
| Developer | 0.005-1.6 | 0.01-1.0 | 0.1-0.5 |
| Flux | 0.5-6.5 | 0.1-6.0 | 1.0-3.0 |
| Surface-active substance | 0.008-2.3 | 0.01-2.0 | 0.2-0.6 |
| Starting components for the | 87.5-99.9 | 90.0-99.5 | 95.0-98.5 |
| production of the thermoset | | | |
| Polymer | 0.05-7.3 | 0.11-6.1 | 0.5-3.0 |

21. A composition according to claim 14, in which the thermochromic composite enables a thermoset to be prepared which exhibits at least one clearly defined colour change in dependence upon the temperature.

22. A composition according to claim 14, in which the thermochromic composite enables a thermoset to be prepared in which, in dependence upon the temperature, a marked colour change takes place within a temperature range of 15 K.

23. A composition according to claim 22, in which a marked colour change takes place within a temperature range of 8 K.

24. A composition according to claim 22, in which a marked colour change takes place within a temperature range of 2 K.

25. A composition according to claim 22, in which at least one colour change is a reversible colour change.

26. A composition according to claim 14, in which the thermochromic composite enables a thermoset to be prepared which has multiple colour change transition points.

27. A composition according to claim 14, in which an isotropic thermoset can be produced.

28. A composition according to claim 22, in which at least one colour change is irreversible.

29. A composition according to claim 14, in which at least two of the components of the thermochromic composite are present functionally within a supramolecular molecule structure.
